(19) United States
(12) Patent Application Publication
(10) Pub. No.: US 2026/0101118 A1
(43) Pub. Date: Apr. 9, 2026

(54) VIDEO ENHANCEMENT

(71) Applicant: Google LLC, Mountain View, CA (US)

(72) Inventors: Lillian CHEN, Mountain View, CA (US); Kevin FU, Mountain View, CA (US); Bhushan MONDKAR, Mountain View, CA (US); Jabi LUE, Mountain View, CA (US); Marius RENN, Mountain View, CA (US); Jerome POICHET, Mountain View, CA (US); Minh NGUYEN, Mountain View, CA (US); Chia-Kai LIANG, Mountain View, CA (US); Fuhao SHI, Mountain View, CA (US); Lu LIU, Mountain View, CA (US); Jen SHUANG, Mountain View, CA (US); Josh NOLAND, Mountain View, CA (US); Clément JULLIARD, Mountain View, CA (US); Paul MARYNCHEV, Mountain View, CA (US)

(73) Assignee: Google LLC, Mountain View, CA (US)

(21) Appl. No.: 19/111,714

(22) PCT Filed: Oct. 3, 2024
(86) PCT No.: PCT/US2024/049851

§ 371 Date: Mar. 13, 2025

(51) Int. Cl. H04N 23/84; H04N 5/77; H04N 7/01

(52) U.S. Cl. CPC H04N 23/84; H04N 5/77; H04N 7/0127

(57) ABSTRACT

A media application receives a request from a user for an enhanced video. The media application records an input video of a scene, where the input video has a first format. The media application converts the input video to a second format. The media application converts the input video to a second format by performing, with an image signal processor, frontend processing and conversion from a Red Green Blue (RGB) color space to a YUV color space, where the input video in the second format has a smaller file size than the input video in the first format. The media application transmits the input video in the second format to a server for cloud processing. The media application receives the enhanced video from the server.

### CROSS-REFERENCE TO RELATED APPLICATIONS

This application is a non-provisional application that claims priority under 35 U.S.C. § 119(e) to U.S. Provisional Patent Application No. 63/542,285, titled “Video Enhancement,” filed on Oct. 3, 2023, the contents of which are hereby incorporated by reference herein in its entirety.

### BACKGROUND

Smartphones and other client devices are commonly used for video capture. The quality of video captured by such devices is limited by sensor hardware as well as local image/video processing capabilities.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method performed on a mobile device includes receiving a request from a user for an enhanced video. The method further includes recording an input video of a scene, wherein the input video has a first format. The method further includes converting the input video to a second format by performing, with an image signal processor of the mobile device, frontend processing and conversion from a Red Green Blue (RGB) color space to a YUV color space, where the input video in the second format has a smaller file size than the input video in the first format. The method further includes transmitting the input video in the second format to a server for cloud processing. The method further includes receiving the enhanced video from the server.

In some embodiments, the frontend processing includes one or more actions selected from a group of linearization, black-level correction, digital gain, green channel imbalance correction, lens shading correction, white balance adjustment, highlight recovery, and combinations thereof. In some embodiments, conversion to the YUV color space includes one or more actions selected from a group of spatial denoising, demosaicing, applying a color correction matrix, and converting a RGB matrix to a YUV format matrix. In some embodiments, converting the input video to the second format further includes: performing quantization of the first format that encodes the input video in 12 bits to the second format that encodes the input video in 10 bits; and interpolating the input video in the first format by adding frames to increase a number of Frames Per Second (FPS) for the input video in the second format. In some embodiments, the first format is a Bayer image format, obtaining the input video in the first format includes obtaining camera sensor data from a camera sensor of the mobile device, and converting the input video to the second format includes converting the camera sensor data in the Bayer image format to a YUV420 layout. In some embodiments, converting the input video to the second format includes performing swizzling using Y-as-green, RGGB-quadrants, RGGB-tracks, or YUV conversions.

In some embodiments, the method further comprises: obtaining camera sensor data from a camera sensor of the mobile device in a Bayer image format; performing remosaicing of the camera sensor data; and performing binning of the camera sensor data. In some embodiments, the method further includes displaying playback of the enhanced video on the mobile device; receiving user selection indicative of a pause of the enhanced video; and displaying, in a user interface, an enhanced frame from the enhanced video, wherein the user interface includes an option to download the enhanced frame. In some embodiments, the method further includes while recording the input video, recording a preview video of the scene; and prior to receiving the enhanced video from the server, providing an option to view the preview video, where the preview video is associated with a lower quality than the enhanced video. In some embodiments, the method further includes performing, with the image signal processor, frontend processing of the preview video, conversion from the RGB color space to the YUV color space, demosaicing, applying a color correction matrix, and merging of long frames and short frames of the preview video to create merged frames.

A non-transitory computer-readable medium with instructions stored thereon that, when executed by one or more computers, cause the one or more computers to perform operations. The operations include: receiving a request from a user for an enhanced video; recording an input video of a scene, wherein the input video has a first format; converting the input video to a second format by performing, with an image signal processor of a mobile device, frontend processing and conversion from a RGB color space to a YUV color space, wherein the input video in the second format has a smaller file size than the input video in the first format; transmitting the input video in the second format to a server for cloud processing; and receiving the enhanced video from the server.

In some embodiments, the frontend processing includes one or more actions selected from a group of linearization, black-level correction, digital gain, green channel imbalance correction, lens shading correction, white balance adjustment, highlight recovery, and combinations thereof. In some embodiments, conversion to the YUV color space includes one or more actions selected from a group of spatial denoising, demosaicing, applying a color correction matrix, and converting a RGB matrix to a YUV format matrix. In some embodiments, converting the input video to the second format further includes: performing quantization of the first format that encodes the input video in 12 bits to the second format that encodes the input video in 10 bits; and interpolating the input video in the first format by adding frames to increase a number of Frames Per Second (FPS) for the input video in the second format. In some embodiments, the first format is a Bayer image format, obtaining the input video in the first format includes obtaining camera sensor data from a camera sensor of the mobile device, and converting the input video to the second format includes converting the camera sensor data in the Bayer image format to a YUV420 layout.

A system comprises a processor and a memory coupled to the processor, with instructions stored thereon that, when executed by the processor, cause the processor to perform operations. The operations include: receiving a request from a user for an enhanced video; recording an input video of a scene, wherein the input video has a first format; converting the input video to a second format by performing, with an image signal processor of a mobile device, frontend processing and conversion from a RGB color space to a YUV color space, where the input video in the second format has a smaller file size than the input video in the first format; transmitting the input video in the second format to a server for cloud processing; and receiving the enhanced video from the server.

In some embodiments, the frontend processing includes one or more actions selected from a group of linearization, black-level correction, digital gain, green channel imbalance correction, lens shading correction, white balance adjustment, highlight recovery, and combinations thereof. In some embodiments, conversion to the YUV color space includes one or more actions selected from a group of spatial denoising, demosaicing, applying a color correction matrix, and converting a RGB matrix to a YUV format matrix. In some embodiments, converting the input video to the second format further includes: performing quantization of the first format that encodes the input video in 12 bits to the second format that encodes the input video in 10 bits; and interpolating the input video in the first format by adding frames to increase a number of Frames Per Second (FPS) for the input video in the second format. In some embodiments, the first format is a Bayer image format, obtaining the input video in the first format includes obtaining camera sensor data from a camera sensor of the mobile device, and converting the input video to the second format includes converting the camera sensor data in the Bayer image format to a YUV420 layout.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIGS. 3A-3D illustrate example user interfaces to obtain an enhanced video, according to some embodiments described herein.

FIG. 4 is a block diagram illustrating blocks of example video stream processing and different processing stages at which a video can be transmitted to a server, according to some embodiments described herein.

FIG. 5 is a block diagram illustrating the processing of camera sensor data when the camera sensor data is transmitted to a server, according to some embodiments described herein.

FIG. 6A illustrates an example of an input video file and a preview video file, according to some embodiments described herein.

FIG. 6B illustrates example parameters of the input video file of FIG. 6A, according to some embodiments described herein.

FIG. 6C illustrates example parameters of the preview video file of FIG. 6A, according to some embodiments described herein.

FIG. 7A illustrates an example of remosaicing of pixels in a Bayer pattern, according to some embodiments described herein.

FIG. 7B illustrates an example of binning of a Bayer pattern, according to some embodiments described herein.

FIG. 7C illustrates the combination of binning and remosaicing, according to some embodiments described herein.

FIG. 8A illustrates an example camera image sensor with phase-difference capabilities, according to some embodiments described herein.

FIG. 8B illustrates types of phase-different (PD) layouts, according to some embodiments described herein.

FIGS. 9A-9B illustrates different pixels patterns between a Bayer pattern and a YUV image format, according to some embodiments described herein.

FIG. 10 is a flowchart that illustrates an example method to obtain an enhanced video, according to some embodiments described herein.

### DETAILED DESCRIPTION

### Overview

The quality of videos captured by mobile devices is limited by sensor hardware, as well as local image/video processing capabilities. The videos may be processed to enhance aspects such as video resolution, color, dynamic range, etc. on a server that has more computational resources. However, storing raw video as captured by an image sensor of a mobile device on a mobile device can be prohibitive due to high storage capacity requirements, energy usage during video capture, and/or limitations of storage bandwidth. For example, on some mobile devices, storing raw sensor data for the video implies a storage load of 0.5 Gigabytes per second for the storage device, which may overwhelm the mobile device. Additionally, even if a raw video file were stored on a mobile device, transmitting raw video from a mobile device to the server can require significant expense and/or time due to bandwidth requirements to send a large size raw video file. Such transmission may also drain the mobile device's battery. Compressing the raw video file is also problematic because lossy compression irreversibly changes the video and causes a loss of information that is essential to improve video quality in post-processing.

The technology described herein advantageously enhances video by performing reversible processing of the input video captured by a camera sensor of a mobile device, e.g., a smartphone, tablet, wearable device, portable camera, or any other device with a camera. The processing provides a video file with a smaller size than a raw format, which makes it feasible to transmitted the processed video to a remote server. For example, in some embodiments, a media application converts the input video from a first format to a second format by performing, with an image signal processor-a dedicated processor (e.g., distinct from a main processor of the device) that is part of the image processing pipeline, before the video is written to a storage device of the mobile deice-frontend processing and Red Green Blue (RGB) processing. A remote server receives the input video in the second format (which is of smaller file size than a raw file and retains useful information captured by the image sensor), enhances the video and transmits an enhanced video file back to the mobile device. In some embodiments, video enhancement by the server can include one or more of correcting videos that are shaky (e.g., by performing a video stabilization operation), grainy, poorly lit, and otherwise imperfect videos. The server provides smooth, detailed, and well-lit enhanced versions of the videos for display or storage at the mobile device, for storage in a user account hosted by a video hosting service associated with a user of the mobile device, for sharing with other users, etc., all with specific user permission to access the video, to perform enhancement, and to store and/or transmit the video.

For example, a media application receives a request from a user for an enhanced video. The media application records an input video of a scene, wherein the input video has a first format. The media application converts the input video to a second format by performing, with an image signal processor of the mobile device, frontend processing and conversion from a RGB color space to a YUV color space, where the input video in the second format has a smaller file size than the input video in the first format. The media application transmits the input video in the second format to a server for cloud processing. The media application receives the enhanced video from the server.

### Example Environment

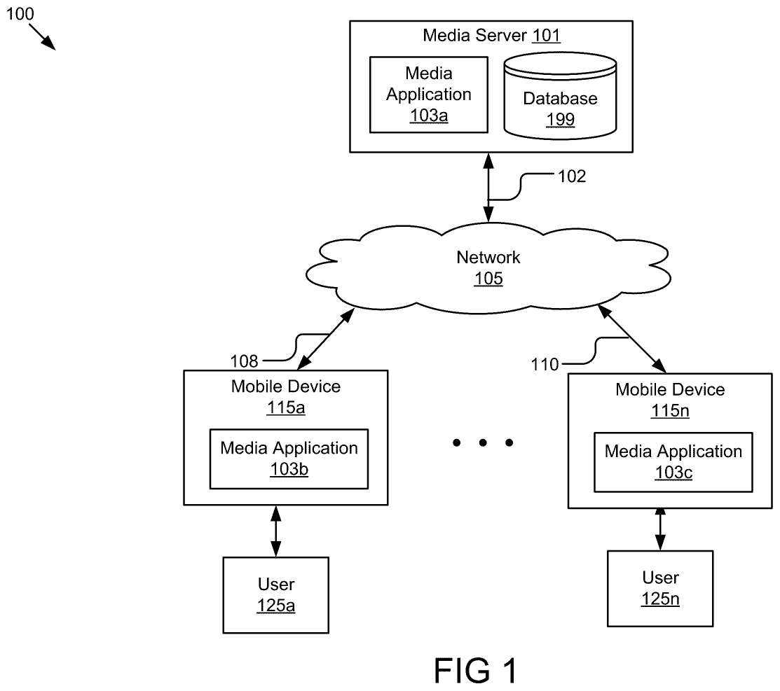

FIG. 1 illustrates a block diagram of an example environment 100. In some embodiments, the environment 100 includes a media server 101, a mobile device 115a, and a mobile device 115n coupled to a network 105. Users 125a, 125n may be associated with respective mobile devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the mobile devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The mobile device 115 may be a computing device that includes a memory coupled to a hardware processor. For example, the mobile device 115 may include a tablet computer, a mobile telephone, a smart device, a wearable device, a head-mounted display, a portable game player, a portable music player, a reader device, or another electronic device capable of accessing a network 105.

The mobile device may include a camera that includes an image sensor such as a CMOS/CCD sensor). In some embodiments, the mobile device may include an image signal processor (ISP), e.g., an application-specific integrated circuit (ASIC) or other type of dedicated processor, coupled to the image sensor. In these embodiments, raw image data (e.g., for one or more frames of a video) captured by the image sensor are provided directly to the ISP (without involvement of a main processor or CPU of the mobile device) for various operations, as explained further below. In some embodiments, the ISP may be purpose-built hardware that include image/video processing circuity that can perform various operations. In some embodiments, the ISP may include a processing unit coupled to a memory that stores a set of instructions for various operations to be performed by the ISP. In some embodiments, the mobile device may implement an image processing pipeline that includes the image sensor (that captures raw data) and the ISP that performs different processing operations on the captured video frames. In some embodiments, video capture by the mobile device may support a plurality of modes, with different combinations of parameters such as video frame rate, video resolution, dynamic range, etc. In some embodiments, the ISP may implement specific processing that corresponds to a user-selected mode.

In the illustrated implementation, mobile device 115a is coupled to the network 105 via signal line 108 and mobile device 115n is coupled to the network 105 via signal line 110. The media application 103 may be stored as media application 103b on the mobile device 115a and/or media application 103c on the mobile device 115n. Signal lines 108 and 110 may be wired connections, such as Ethernet, coaxial cable, fiber-optic cable, etc., or wireless connections, such as Wi-Fi®, Bluetooth®, or other wireless technology. Mobile devices 115a, 115n are accessed by users 125a, 125n, respectively. The mobile devices 115a, 115n in FIG. 1 are used by way of example. While FIG. 1 illustrates two mobile devices, 115a and 115n, the disclosure applies to a system architecture having one or more mobile devices 115.

The media application 103 may be stored on the media server 101 or the mobile device 115. In some embodiments, the operations described herein are performed on the media server 101 or the mobile device 115. In some embodiments, some operations may be performed on the media server 101 and some may be performed on the mobile device 115. Performance of operations is in accordance with user settings. For example, the user 125a may specify settings that operations are to be performed on their respective device 115a and not on the media server 101. With such settings, operations described herein are performed entirely on mobile device 115a and no operations are performed on the media server 101. Further, a user 125a may specify that images and/or other data of the user is to be stored only locally on a mobile device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

The media application 103b on the mobile device 115a receives a request for an enhanced video from a user. The media application 103b instructs a camera on the mobile device 115a to record a preview video of a scene and an input video of the scene. The input video is recorded in a first format. The media application 103b converts the input video to a second format, where the input video in the second format has a smaller file size than the input video in the first format. In some embodiments, a user may record a video first and request an enhanced video after the initial recording. In some embodiments, a user may initiate recording while providing a command that an enhanced video is to be provided to the user.

The media application 103b transmits the input video in the second format to the media server 101 for cloud processing. The media application 103a on the media server 101 generates an enhanced video. In some embodiments, the media application 103a enhances the input video by performing denoising, deblurring, brightening, three-dimensional stabilization, and/or interpolation to correct shaky, grainy, poorly lit, and otherwise imperfect videos.

While the media server 101 processes the input video, the media application 103b provides an option to view the preview video. The media application 103a on the media server 101 enhances the video. For example, the media application 103a may perform one or more color correction, sharpen the image (one or more frames of the video), improve visibility of the scene when video is captured at night or under low light conditions, remove or reduce shakiness, enhance dynamic range, etc. The media application 103b receives the enhanced video from the media server 101. The media application 103b provides the enhanced video, for example, by adding the enhanced video to the mobile device's 115a camera roll.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Example Computing Device

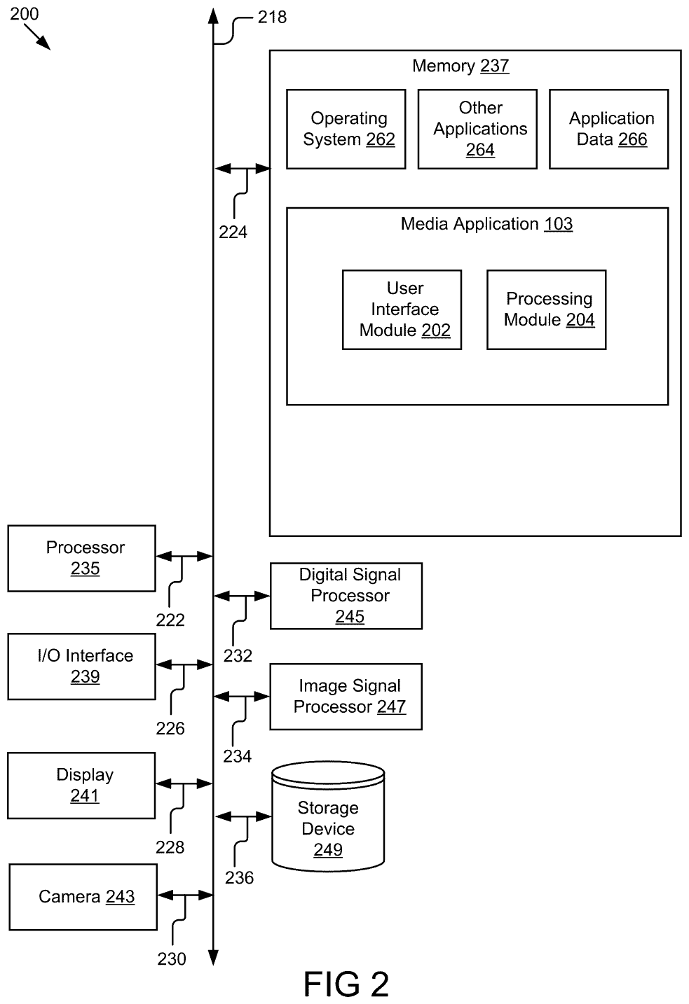

FIG. 2 is a block diagram of an example computing device 200 that may be used to implement one or more features described herein. Computing device can be any suitable computer system, server, or other electronic or hardware device. In some embodiments, the computing device 200 is a mobile device 115 in FIG. 1.

In some embodiments, computing device 200 includes a processor 235, a memory 237, an input/output (I/O) interface 239, a display 241, a camera 243, a digital signal processor 245, an image signal processor 247, and a storage device 249, all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, the digital signal processor 245 may be coupled to the bus 218 via signal line 232, the image signal processor 247 may be coupled to the bus 218 via signal line 234, and the storage device 249 may be coupled to the bus 218 via signal line 236.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 249), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 includes multiple lenses, such as a front lens, a main lens, and an ultrawide lens. The camera 243 includes camera image sensors (e.g., a CMOS sensor, a CCD sensor, or any sensor that captures light as an image) that capture sensor data that is transmitted to the digital signal processor 245 and/or the image signal processor 247 via the I/O interface 239.

In some embodiments, the camera 243 includes phase-difference (PD) sensor capabilities, where every pixel on the camera image sensor is composed of two side-by-side diodes under a single lens. In some embodiments, other combinations of lens and diodes can be used in different PD sensor confirmations.

The digital signal processor (DSP) 245 includes hardware for converting digital electrical signals into a digital output signal. In some embodiments, the digital signal processor 245 measures, filters, or compresses the signal from camera sensors. The digital signal processor 245 receives analog signals from camera sensors, converts the analog signals to digital signals, manipulates the digital signals, and converts the manipulated digital signals to manipulated analog signals.

In some embodiments, camera 243 may be coupled directly to ISP 247 and/or to DSP 245, bypassing the system bus 218 and the processor 235. In these embodiments, images/video frames (raw sensor data) captured by the camera are provided directly to ISP 247 and/or DSP 245 for processing. The processed video may then be displayed on display 241 (e.g., a preview video) and/or stored in storage device 249 (e.g., a compressed video obtained after processing the input video). In some embodiments, ISP 247 and/or DSP 245 may include dedicated circuitry for image/video processing of raw data. In some embodiments, a mode selection for image/video capture may cause ISP 247 and/or DSP 245 to perform a specific set of operations that correspond to the selected mode.

The image signal processor (ISP) 247 receives camera image sensor data from the camera 243 and performs image processing of the camera image sensor data associated with videos captured by the camera 243. In some embodiments, the ISP 247 receives instructions from the media application 103 via the I/O interface 239 to perform one or more of a Bayer transformation, demosaicing, noise reduction, and image sharpening of the image data associated with the videos. In some embodiments, the ISP 247 may include a multiple camera and frame processor (MCFP) that merges long and short 12-bit frames together to create one high-dynamic 12-bit frame.

The storage device 249 stores data related to the media application 103. For example, the storage device 249 may store images, preview videos, input videos in a first format, input videos in a second format, enhanced videos received from a media server 101, etc.

FIG. 2 illustrates an example media application 103, stored in memory 237. The media application 103 includes a user interface module 202 and a processing module 204.

The user interface module 202 generates graphical data for displaying a user interface that is associated with the camera 243. For example, the user interface includes options for capturing an image, capturing a video, initiating settings for obtaining enhanced videos, etc.

The user interface module 202 obtains permission from a user to modify videos, including uploading videos to a server, performing server-side video processing to generate an enhanced video, downloading the enhanced video from a server, etc. The user may be provided with controls allowing the user to make an election as to both if and when systems, programs, or features described herein may enable collection of user information (e.g., a video captured by the user with a camera or otherwise obtained by the user, a user's preferences, etc.), and if the user is sent content or communications from a server. In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

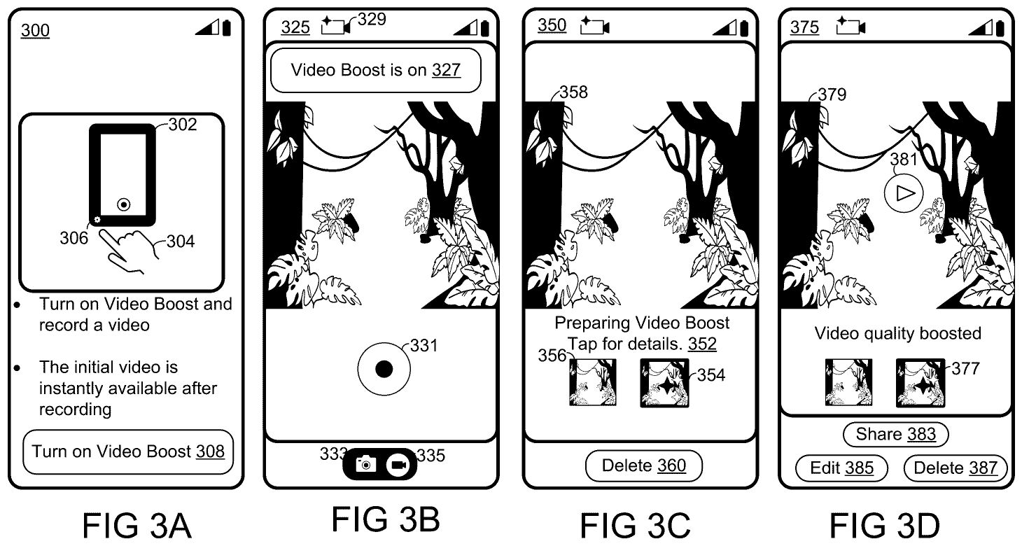

FIGS. 3A-3D illustrate example user interfaces of the process of obtaining an enhanced video, according to some embodiments described herein. FIG. 3A includes a first user interface 300 with an image of a mobile device 302 and a hand 304 (denoting user's touch input) approaching a settings button 306. The first user interface 300 includes a “Turn on Video Boost” button 308 that, when selected, makes an option for turning on video boost setting visible on for a video.

In some embodiments, after the video boost setting is enabled, the user can select video boost each time the user wants to obtain an enhanced video. In some embodiments and with user permission, video boost may automatically turn on for certain conditions, such as in low light or when a video is recorded in shaky settings (e.g., due to a user's shaky hand, due to recording while moving, etc.). In some embodiments, the user interface module 202 provides a suggestion to a user to turn on video boost in response to certain lighting conditions, such as in low light.

FIG. 3B illustrates a second user interface 325 where video boost has been enabled. In some embodiments, the second user interface 325 includes the “Video Boost is on” 327 message the first time the user enables the video boost setting. The second user interface 325 includes a video boost icon 329 that is displayed to signal to the user that an enhanced video will be created based on a user captured video. The user starts recording by selecting the record button 331. The second user interface 325 also includes a camera icon 333 and a video icon 335 so that the user can capture images and video, respectively. The video icon 335 is highlighted to indicate that the mobile device is in video capture mode. In various user interfaces, additional options may be provided, e.g., to enable the user to select image/video capture mode, to set or adjust a zoom level, to control camera settings, etc.

Once the recording of the video is complete, high resolution (4K) video data for the input data is securely and with specific user permission, transmitted to the media server 101 for processing.

FIG. 3C illustrates a third user interface 350 after the video is captured. The third user interface 350 includes text 352 informing the user that Video Boost is being prepared and instructs the user to tap the enhanced video icon 354 for details. Tapping the enhanced video icon 354 may result in an estimation of an estimated amount of time to process the input video and provide the enhanced video (not shown). The enhanced video icon 354 is highlighted to show that the delete button 560 setting applies to the enhanced video. A first frame 358 from the enhanced video is displayed in the third user interface 350 while the enhanced video is being prepared. If the user selects the delete button 360, the user interface module 202 notifies the media server 101 to stop generating the enhanced video.

During recording, the mobile device captures a preview video and an input video in a first format that is used to generate an enhanced video. The preview video is viewable after the video is recorded by pressing the preview video button 356.

FIG. 3D illustrates a fourth user interface 375 after the enhanced video 379 is available. The enhanced video icon 377 is highlighted and the enhanced video 379 is playable by pushing the play button 381. Responsive to the user pushing the play button 381, the user interface module 202 displays playback of the enhanced video. The user interface may receive user selection indicative of a pause of the enhanced video. The user interface displays an enhanced frame from the enhanced video with an option to download the enhanced frame.

The user may share the enhanced video by selecting the share button 383, edit the enhanced video by selecting the edit button 385, or delete the enhanced video by selecting the delete button 387. In some embodiments, pressing the delete button 387 causes the user interface module 202 to display a question about whether the user wants to delete the enhanced video from only the mobile device or also from cloud storage. In some embodiments, the user may also be provided an option to extract an individual frame (or a portion thereof) from the enhanced video as a still image.

When image data for a video is captured by camera image sensors of a camera 243, the ISP 247 processes the image data. Some of the processing is advantageous for transmitting an input video to a media server 101 because the processing results in a video file that is smaller than the input video captured by the camera image sensors. However, different processing steps in an image processing pipeline may result in corresponding irreversible changes that are made to the input video, e.g., where data captured by the camera image sensors is modified. Such changes may limit the video enhancement that can be performed at the media server 101. As a result, there may be different advantages and disadvantages to choosing when to select a particular processing step from which the video obtained transmission to the media server 101 for enhancement.

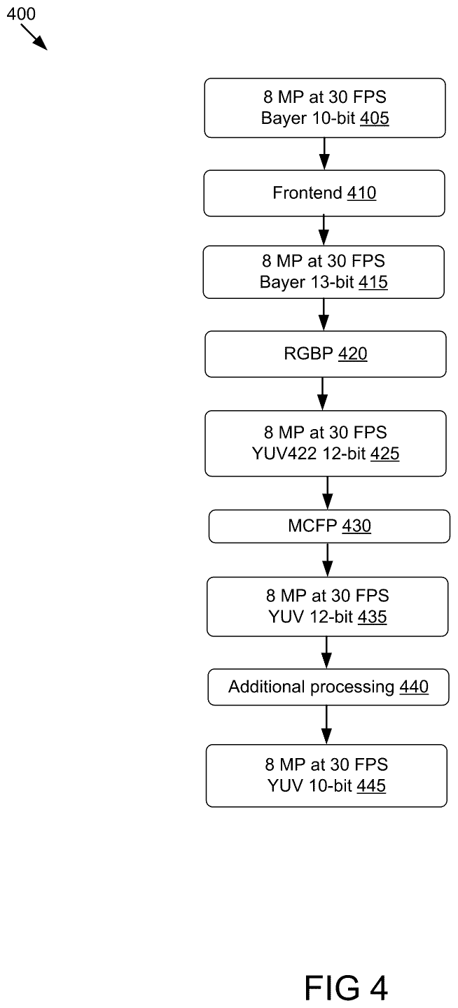

FIG. 4 is a block diagram 400 illustrating blocks of example video stream processing and different processing stages at which a video stream can be transmitted to the media server 101, according to some embodiments described herein. The processing is performed by the ISP 247.

The initial video data 405 captured by the camera image sensors may be at 8 MegaPixels (MP) at 30 Frames Per Second (FPS) in a Bayer image format and encoded with 10 bits. The Bayer image format is a color image encoding format for capturing color information from a single sensor. The 10 bits refer to the number of bits taken up by the image format (bit depth). The initial video data has not been processed by the ISP 247 and is referred to as raw image data.

Frontend processing 410 includes one or more of linearization, black-level correction, digital gain, green channel imbalance correction, lens shading correction, white balance adjustment, and highlight recovery. Linearization occurs when sensor values describing red, blue, and green pixels that form non-linear plots are converted to linear plots, such as by using an inverse power curve. In some embodiments, linearization includes the ISP 247 applying tone decompression, linearization of extreme highlights, and compensation for non-linearity in shadows caused by flare. The ISP 247 may perform lack-level correction by subtracting a black-level offset value from the pixel values. The ISP 247 may perform digital gain by using a scalar value to scale the pixel values of the red, blue, and green channels to improve image exposure. The ISP 247 may perform green channel imbalance correction by adjusting the gain for green pixels residing in red lines and blue lines and aligning the lines more closely. The ISP 247 may perform lens shading correction to correct for distortion that occurs from using a spherical lens. The ISP 247 may perform white balance adjustment by performing calibration and adjusting color gains to achieve a neutral white or a neutral grey in the image. The ISP 247 may perform highlight recovery by applying positive brightness correction and moving an exposure slider in a raw converter to reveal hidden information in an image. The ISP 247 may perform highlight recovery by first optimizing for an overall tone, second by optimizing for highlights, and then blending the two processed versions.

During frontend processing 410, the ISP 247 may also create small, slightly processed buffers for analysis and a Gaussian pyramid for motion estimation, used in staggered High-Dynamic Range (sHDR) frame merge or temporal denoising. In some embodiments, sHDR may allow reading out multiple exposures from an image sensor, e.g., a short exposure value corresponding to a short exposure image may be captured first as the camera image sensor continues to be exposed (to light from the scene). At a later time, a second exposure value) can be captured for the same scene to obtain a longer exposure image.

In some embodiments, zigzag HDR may be utilized, where different sensor pixels of the camera image sensor are exposed for different times. This makes it possible to obtain multiple exposures for a single read-out. However, in this technique, the image data for a single exposure may be of a lower resolution since only a subset of sensor pixels are used for data capture.

In some embodiments, the output video data 415 after the front-end processing is 8 MP at 30 FPS in the Bayer image format and encoded with 13 bits. In various embodiments, different frame rates and/or bit depths may be used.

The Red Green Blue Processing (RGBP) 420 includes conversion from a RGB color space to a YUV color space. YUV stands for luma (i.e., brightness) and chrominance, which is represented by blue projection (U) and red projection (V).

In some embodiment, RGBP 420 includes performing first-stage spatial denoising, demosaicing, applying a color correction matrix (CCM), and RGB2YUV, which converts a RGB matrix to a YUV matrix. After RGBP 420, the video data is 8 MP at 30 FPS in the YUV422 image format and encoded with 12 bits 425. The YUV422 image format is a YCbCr format that is capable of describing any 4:2:2 chroma-subsampled format with eight bits per color sample. The YUV data format shares U and V values between two pixels.

Multiple camera and frame processor (MCFP) 430 performs motion estimation and expands a dynamic range of the image. After third level processing 430, the video data 435 is 8 MP at 30 FPS in the YUV image format and encoded with 12 bits.

Additional processing 440 may include one or more of second-stage spatial denoising, local tone mapping (HDRnet), sharpening, and color enhancement. These operations are usually non-linear and difficult to revert. Therefore, when these introduce information (e.g., texture, details, etc.), loss, or artifacts (e.g., blurring, aliasing, etc.), the processing may take more effort to revert/correct and may be irreversible. The additional processing 440 may also include one or more of fetching motion estimation result, applying a temporal filter, performing mesh-based warping to the frame, cropping, and scaling to fit the frame into the final target resolution. The mesh-based warping may be used for stabilization, lens distortion correction, focus breathing compensation, and their combinations. After additional processing 440, the video data 445 is 8 MP at 30 FPS in the YUV image format and encoded with 10 bits.

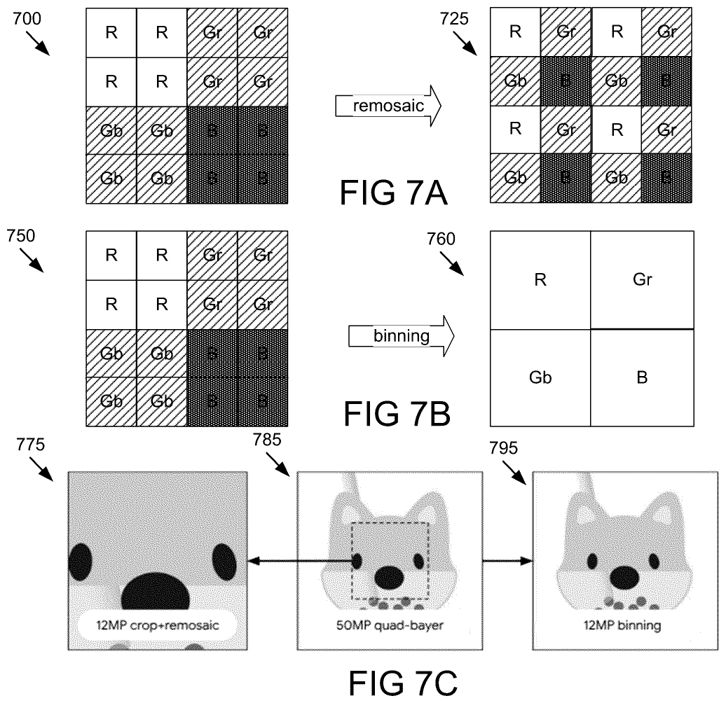

In some embodiments, video data 405 may be transmitted to the media server 101 before or after each processing block in FIG. 4. If the video data 405 is transmitted to the media server 101 before the frontend processing 410, the ISP 247 may swizzles the video data 405 to YUV420, since many video codecs do not support the raw format of the video data 405. Swizzling and other processes performed by the ISP 247 are discussed in greater detail below with reference to FIGS. 7-9. The YUV420 is a YCbCr format that describes any 4:2:0 chroma-subsampled planar or semi-planar buffer with eight bits per color sample.

The advantages of transmitting the video data 405 at this stage include that it is the least-modified version of the sensor data, there is little processing that the ISP 247 needs to perform, clipping to avoid artifacts as performed by the ISP 247 is avoided, and the sensor data is easier to test.

If the video data 415 that results after the frontend processing 410 is transmitted to the media server 101, some common distortions in the raw images are corrected in the video data 415, which may make the data more compression friendly. However, without denoising, the images may still be noisy in low-light conditions. Similar to above, the ISP 247 swizzles the video data 415 to YUV420. The advantages of transmitting the video data 415 at this stage include that some corrections may help compression efficiency and no clipping by RGBP, MCFP, or other processing blocks occurs.

If the video data 425 after the RGBP 420 is transmitted to the media server 101, the advantages include that the sHDR frame fusion is not yet applied, most nonlinear processes are not yet applied, first-stage spatial denoising is applied, and no clipping by MCFP occurs.

If the video data 435 after MCFP processing 430 is transmitted to the media server 101, the advantages may be that because the long exposure and short exposure frames are merged, the video data is half the size of transmitting the video data 435 before MCFP processing 430 and first-stage spatial denoising is applied.

If the video data 445 after fourth level processing 430 is transmitted to the media server 101, the advantages may be that all ISP denoising is applied, the YUV10 stream is obtained through ISP 247 making testing easier, and the image format is viewable and sharable without modification (e.g., as a preview video).

In various embodiments, video data from a particular stage of processing as described with reference to FIG. 4 may be sent to the media server 101 for enhancements. In some embodiments, the choice of stage may be based on the available local processing resources (e.g., capabilities of ISP 247), power (battery level of the device), communication bandwidth to the media server 101, etc. In some embodiments, the choice of stage may further be based on a user selected setting (e.g., video capture mode), scene attributes (e.g., low light scene vs. normal light, scene with significant motion, or static scenes with little or low motion), etc.

The processing module 204 obtains video data for an input video from the ISP 247 (e.g., video data 405, 415, 425, 435, or 445) and compresses the video data by applying a hardware and/or software codec. The codec compresses the video data by pruning coefficients from the block Discrete Cosine Transform (DCT) tables. In some embodiments, this is done by quantizing the coefficients and removing any insignificant values (e.g., zeros). Codecs may control compression based on a minimum quantization value per frame (e.g., 0), a maximum quantization value per frame (e.g., 22), and bitrate that specifies the desired number of bits/bytes to write per second (e.g., 240 Megabits Per Second (Mbps)).

Applying the compression format reduces the file size of the input video. After the video data is processed by the ISP 247 and compressed, the input video is associated with a second format. The processing module 204 transmits the input video associated with a second format to the media server 101.

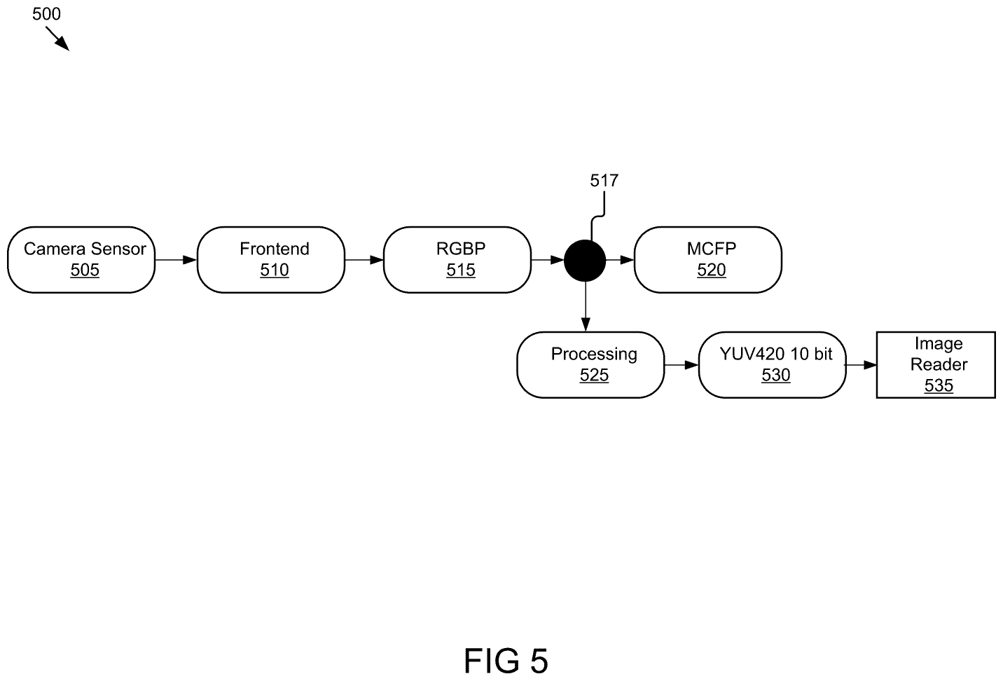

FIG. 5 is a block diagram of an example flowchart 500 of image processing of camera sensor data when the camera sensor data is transmitted to the media server 101. During recording of a video, a camera image sensor 505 captures camera sensor data. The camera sensor data is transmitted to the ISP 247 for frontend processing 510 and then RGBP processing 515. In some embodiments, the camera sensor data is bifurcated at a tap-out point 517 where the camera sensor data received at the tap-out point 517 is prepared for transmission to the media server 101. The camera sensor data also undergoes MCFP processing 520 to obtain a preview video that can be accessed locally on a mobile device, e.g., a smartphone or other device that captured the video while the camera sensor data is used to generate an enhanced video at the media server 101.

The camera sensor data may be processed 525 before the camera sensor data is transmitted to the media server 101. The processing may include converting the camera sensor data from a 12-bit image to a 10-bit image (YUV420-10b image format 530) using a quantization method that rounds values to their nearest counterparts. In some embodiments, the camera sensor data is converted to a 10-bit image because the encoder used by the media server 101 supports 10-bit images and not 12-bit images and because the 10-bit image has a smaller file size. The source YUV422 image is sub-sampled 530 to YUV420 using an interpolation/sampling method. In some embodiments, the interpolation/sampling method converts the camera sensor data from 30 FPS to 60 FPS by using neighboring frames during interpolation to add frames to the camera sensor data and shift the camera sensor data to 60 FPS. The 10-bit image is transmitted to an image reader 535.

In some embodiments, images are read from the camera using an image reader 535. Images are further processed and used by retrieving the hardware buffer that stores the image data. The images may have an image format of YCBCR_P010 and the hardware buffer format may be YCBCR_P010. The images that are read from the image reader 535 may be compressed and transmitted to the media server 101.

The determination of what stage to have a tap-out-point 517 where the camera sensor data is extracted, compressed, and saved to the mobile device and transmitted as an input video to a server is based on a time required for the ISP 247 to process the camera sensor data. The longer in the video recording process that the camera sensor data is saved to the mobile device, the more the camera sensor data is processed locally, which may result in irreversible changes being made to the image data (as described with reference to FIG. 4) that interfere with reconstruction of the original sensor values. These changes may manifest as reduction in detail due to processes like denoising, clipping of highlights and shadows due to adjustments like white-balance and lens shading, and quantization due to reduction in bit-depth. Placing the tap-out-point 517 between RGBP processing 515 and MCFP processing 520 represents a compromise between the file size and avoiding potentially irreversible processing.

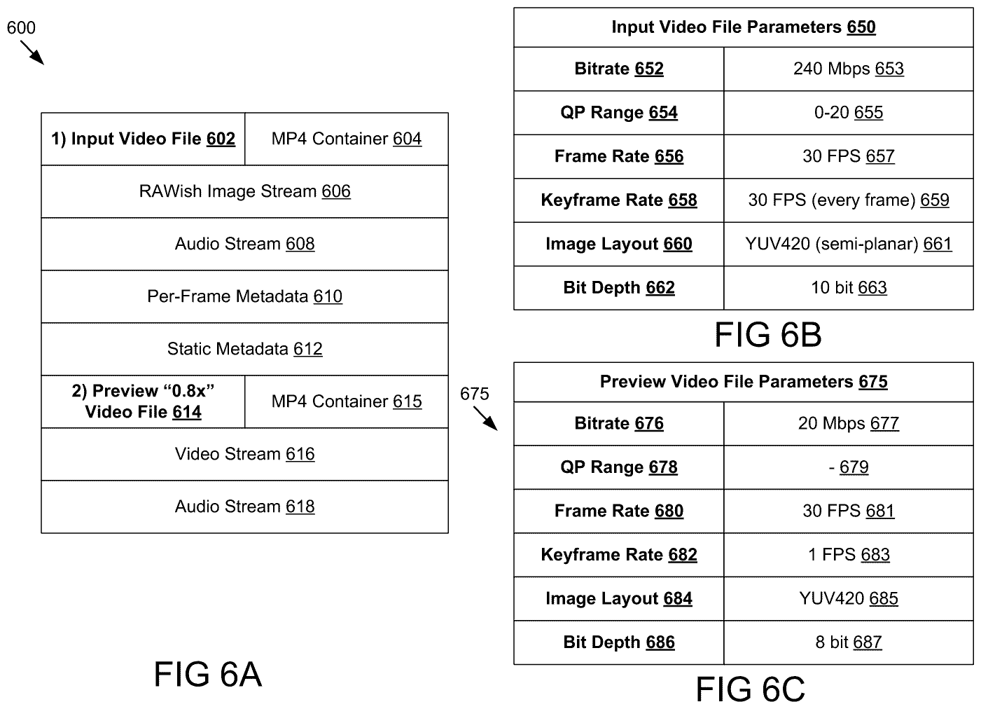

FIG. 6A illustrates an example 600 of an input video file 602 and a preview video file 614. The input video file 602 uses a Moving Pictures Expert Group 4 (MP4) container format 604. The input video file 602 includes a RAWish image stream 606, an audio stream 608, per-frame metadata 610, and static metadata 612. In some embodiments, the RAWish image stream 606 is the camera sensor data that is read from the image reader 535 in FIG. 5.

The camera sensor data is referred to as RAWish because it is similar to a RAW image format with some processing performed by the ISP 247 (e.g., that alters the raw sensor data minimally). The per-frame metadata 610 may include a frame metadata version, a serialized frame metadata length, serialized frame metadata, a serialized spatial gain map length, and a serialized spatial gain map. The static metadata 612 may include a version, a serialized static metadata length, and serialized static metadata.

The preview video file 614 is referred to as a 0.8× video because it is unenhanced. The preview video file 614 also uses an MP4 container 615 and includes a video stream 616 and an audio stream 618. In some embodiments, the order of the tracks in the MP4 container 615 (or other video container) may be undefined. Other container types may be used for the input video file 602 and the preview video file 614.

FIG. 6B illustrates example parameters of the input video file 650 of FIG. 6A. The input video file 650 has a bitrate 652 of 240 Megabytes per second (Mbps) 653, a quantization parameter (QP) range 654 of 0-20 (i.e., a maximum of 20 QP with no minimum set) 655, a frame rate 656 of 30 FPS 657, a keyframe rate 658 of 30 FPS (i.e., every frame is encoded to be a keyframe), an image layout 660 of YUV420 that is semi-planar 661, and a bit depth 662 of 10 bits 663. In some embodiments, the file may be generated at a particular stage, such as the different processing stages described in FIG. 4.

FIG. 6C illustrates preview video file parameters 675 of the preview video file of FIG. 6A. The preview video file parameters 675 includes a bitrate 676 a 20 Mbps, a QP range 678 with no quantization bounds set 679, a frame rate 680 of a 30 FPS 681, a keyframe rate 682 of a 1 FPS 683, an image layout 684 of a YUV420 685, and a bit-depth 686 of 8 bits 687. In some embodiments, the preview video file may be generated at the MCFP processing step 520 of FIG. 5.

FIG. 7A illustrates an example of remosaicing of pixels in an image, according to some embodiments described herein. When an image sensor captures image data that is organized in a Quad Bayer structure or a Tetracell, the image sensor captures red, blue, and green colors at each photosite. Twice as many green photosites are recorded as blue and green because the human eye is more sensitive to the color green.

The Bayer pattern 700 is arranged with four adjacent pixels that are clustered with same-colored pixels. The pixels are illustrated as R for red, Gr for the green pixels that are next to the red pixels, Gb for the green pixels that are next to the blue pixels, and B for blue.

The ISP 247 may perform remosaicing of the pixels in the image by further subdividing every color pixel (R, Gr, Gb, B) into four subpixels and rearranging the pattern into a higher resolution Bayer pattern 725 with an R, Gr, Gb, B interleaved layout. Remosaicing may result in enhanced resolution, less blur, reduction of artifacts, and provides up to 50 MegaPixels (MP) of image data.

FIG. 7B illustrates an example of binning of a Bayer pattern 750, according to some embodiments described herein. In some embodiments, the ISP 247 performs binning by combining each of the quadrants into a single channel to obtain a lower-resolution image. Binning is advantageous for capturing images in low-light situations and improving the quality by combining pixels to create bigger pixels. In some embodiments, the size is changed from 50 MP to 12 MP (since 4 pixels are combined into 1 pixel during the binning).

Using binning alone for an encoded video stream, the video may have poor zoom resolution. Using remosaicing alone may result in a video file size that is too large for a mobile device and beyond the capabilities of codec to process. In some embodiments, the ISP 247 performs both remosaicing and binning. For example, the ISP 247 may perform binning over an image sensor and crop into the center region to obtain a 12 MP sensor crop at equally high resolution as remosaicing alone. This may make the digital zoom quality sharper than using upscaling techniques. Other types of Bayer patterns, such as 5×5 tetracells that emit different remosaicing results may be used as well.

FIG. 7C illustrates the combination of binning and remosaicing, according to some embodiments described herein. FIG. 7C illustrates an example portion of an image 775 with a 12 MP crop in the center region and remosaicing, the original 50 MP Quad Bayer structure 785, and an example image 795 that is reduced to 12 MP as a result of binning. Image 795 is a low resolution image compared to image 785, whereas image 775, while 12 MP image, is a zoomed-in region (as illustrated by dotted lines in image 785) of the image 785.

In some embodiments, the ISP 247 may achieve high dynamic range (HDR) by combining multiple exposures of a scene into a single shot. For example, the camera may capture a long shot and a short shot. However, this increases the exposure times in images. In some embodiments, the sensor employs zigzag HDR where different sensor pixels are exposed for different times. This makes it possible to obtain multiple exposures for a single read-out, possibly at lower resolution for individual exposures.

In some embodiments, the ISP 247 uses staggered HDR (sHDR) to read out multiple exposures simultaneously. As sensor data is read out for one exposure, the sensor continues to be exposed. The ISP 247 may perform another simultaneous read-out for a longer exposure image.

In some embodiments, a multiple camera and frame processor (MCFP) merges long and short 12-bit frames together to create one high-dynamic 12-bit frame.

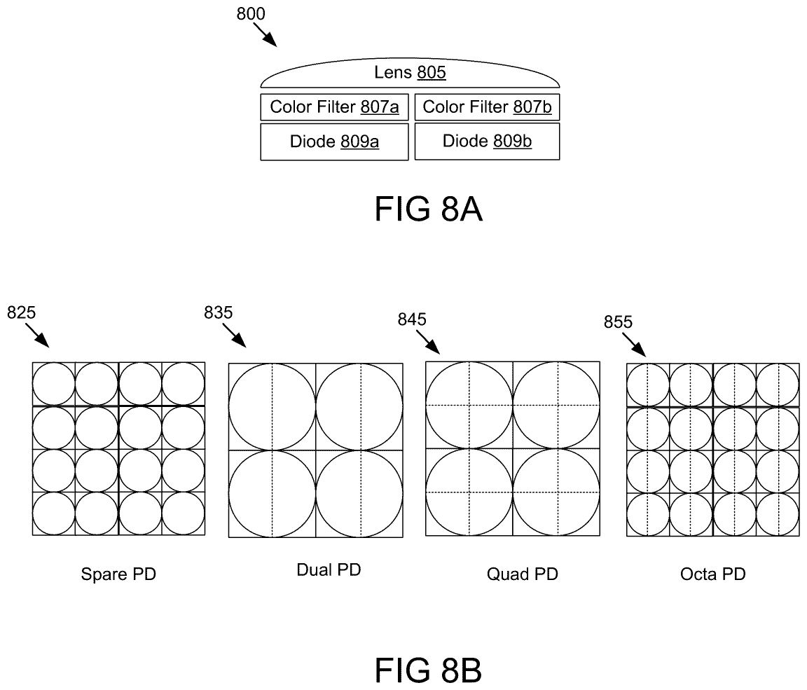

In some embodiments, the camera 243 includes phase-difference (PD) sensor capabilities, where every pixel on the sensor is composed of two side-by-side diodes under a single lens. The sensor obtains two values per pixel that each measure a different phase (or directionality) of the incoming light. FIG. 8A illustrates an example camera image sensor 800 with phase-difference capabilities, according to some embodiments described herein. The camera image sensor 800 includes a lens 805, two diodes 807a, 807b, and two diodes 809a, 809b. PD signals are helpful for auto-focus, and also more generally, provide data about the distance of objects to the sensor. The PD signal is useful for technologies where depth-of-field (or bokeh) effect is applied to the image or video.

FIG. 8B illustrates types of PD layouts, according to some embodiments described herein. In some embodiments, the camera employs a sparse PD layout 825, in which only a portion of the pixels on the sensor measure the phase difference. The front camera (e.g., on the same side as a user facing primary display of a smartphone or other device) may use a dual PD layout 835 in which every pixel on the sensor has two diodes to measure phase. An ultrawide camera (e.g., a second camera on a smartphone on an opposite side of the device as the primary display) may use a quad PD layout 845 in which every pixel has four diodes to measure phase differences in both the horizontal and vertical directions. The main camera on the same side as the ultrawide camera may use an octa PD layout 855 (e.g., a 4×2 pattern) in which every subpixel of the quad-Bayer pattern has two side-by-side diodes.

In some embodiments, the input video image format is a single 10-bit image format that a hardware codec can compress called YUVP010. YUVP010 may be a YUV420 semi-planar layout, where the U and V chroma channels are subsampled 4:1 with reference to the luminance (Y). The different tap-out points during ISP processing are in different formats except for the final tap-out point. As a result, image data obtained from the ISP 247 may be converted to this image format.

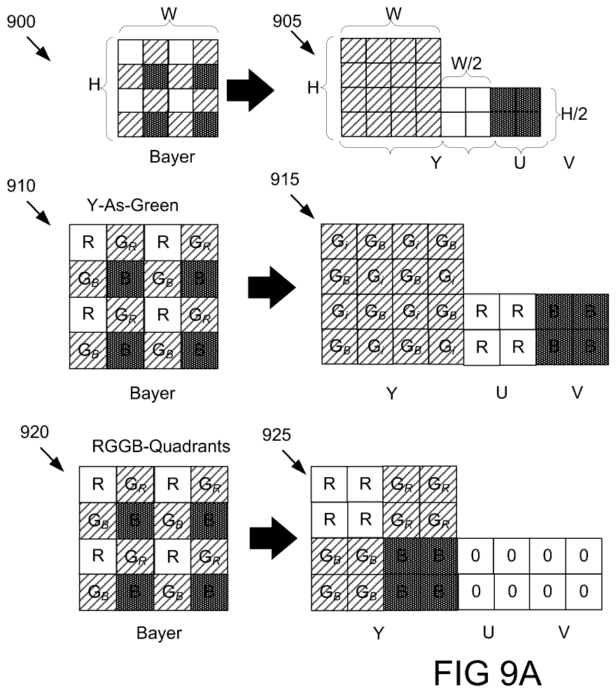

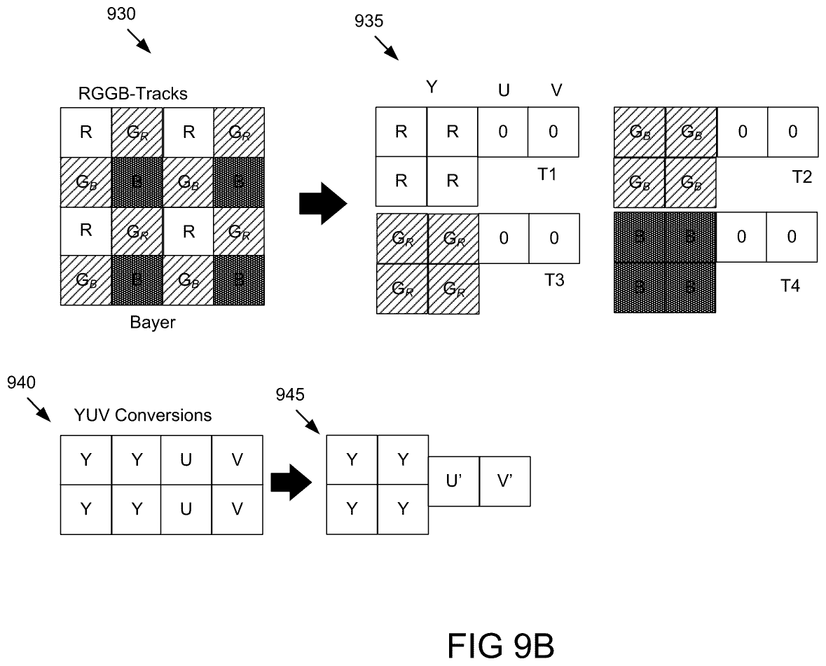

FIGS. 9A-9B illustrates different pixels patterns between a Bayer pattern and a YUV image format, according to some embodiments described herein. The YUV420 image format has a higher capacity than the RAW image format at the same dimensions and bit depth. A Bayer pattern 900 for RAW data contains all color data in a single width by height (W×H) plane of interleaved pixels, while the YUV pattern 905 contains a grayscale W×H plane (Y) followed by the chroma planes (U, V), which are each half of the width and height (W/2, H/2).

Swizzling is used to reinterpret raw data (e.g., with four channels that take the form of RGGB) as a three-channel YUV image. Swizzling may take several forms. In one example, swizzling from a Bayer pattern 910 to YUV 915 uses a Y-as-green technique where the Y channel of YUV is used to store GR and GB pixel values while the U and V channels are used to store red and blue (R, B) pixel values from the Bayer pattern. The Y-as-green technique may need extra computation to interpolate, but is more natural in color, which makes it easier to compress.

In another example, swizzling from a Bayer pattern 920 to YUV 925 using RGGB-quadrants may be used. In this example, the Y channel has four quadrants-one each for GR, GB, R, and B pixel values from the Bayer pattern. In this example, the U and V channels are set to zero values.

In another example, illustrated in FIG. 9B, swizzling from a Bayer pattern 930 to YUV 935 using RGGB-tracks may be used. In this example, the pixel values from the Bayer pattern are split into four tracks (T1-T4), with one track each for G_{R}, G_{B}, R, and B pixel values from the Bayer pattern. The Y channel of each track stores the pixel values, while the U and V channels are set to zero values.

Lastly, in another example, a conversion from YUV 940 to YU′V′ 945 is illustrated.

### Example Flowchart

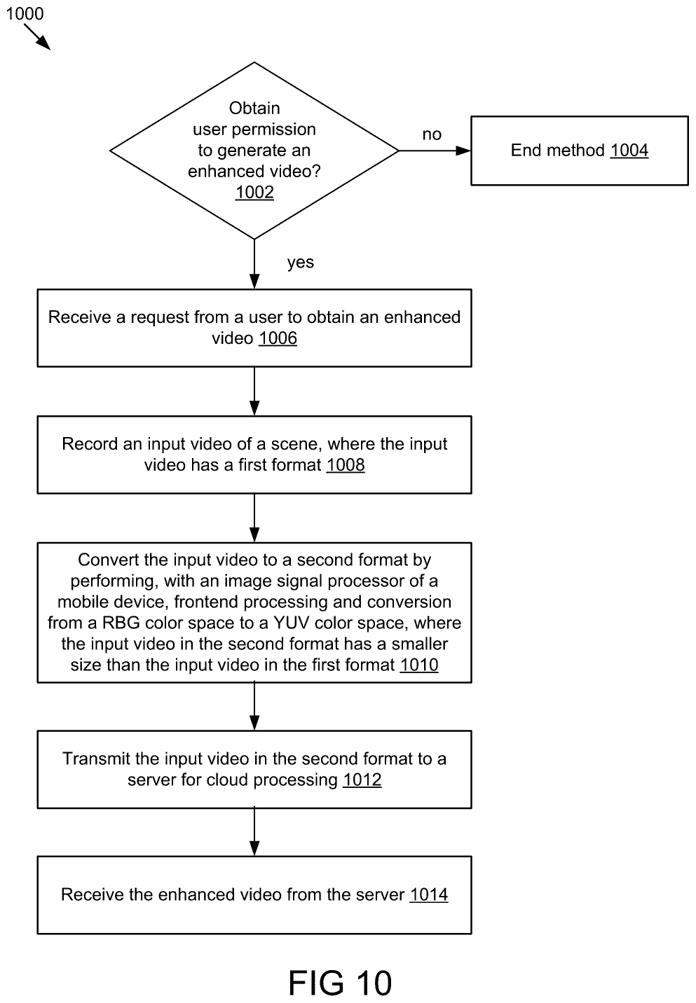

FIG. 10 illustrates an example flowchart to obtain an enhanced video. The method 1000 may be performed by the computing device 200 in FIG. 2. In some embodiments, the method 1000 is performed by the mobile device 115 of FIG. 1.

The method 1000 of FIG. 10 may begin at block 1002. At block 1002, it is determined whether user permission is obtained from a user to generate an enhanced video. If no permission is obtained, the method may end at block 1004 with no processing performed to generate an enhanced video. In this case, the captured video is stored locally on the user device, but is not transmitted to a server or other device for video enhancement. If user permission is obtained, block 1002 may be followed by block 1006.

At block 1006 a request is received from a user to obtain an enhanced video. The user may request an enhanced video at the time of recording, select a preference for input videos to automatically be converted into enhanced videos, etc. Block 1006 may be followed by block 1008.

At block 1008, an input video of a scene is recorded, where the input video has a first format. Block 1008 may be followed by block 1010.

At block 1010, the input video is converted to a second format by performing, with an image signal processor of a mobile device 115, frontend processing and conversion from a RGB color space to a YUV color space, where the input video in the second format has a smaller size than the input video in the first format. Frontend processing may include one or more actions selected from a group of linearization, black-level correction, digital gain, green channel imbalance correction, lens shading correction, white balance adjustment, highlight recovery, and combinations thereof. Conversion to the YUV color space may include one or more actions selected from a group of spatial denoising, demosaicing, applying a color correction matrix, and converting a RGB matrix to a YUV format matrix.

In some embodiments, converting the input video to the second format further includes performing quantization of the first format that encodes the input video in 12 bits to the second format that encodes the input video in 10 bits and interpolating the input video in the first format by adding frames to increase a number of Frames Per Second (FPS) for the input video in the second format. In some embodiments, the first format is a Bayer image format, obtaining the input video in the first format includes obtaining camera sensor data from a camera sensor of the mobile device, and converting the input video to the second format includes converting the camera sensor data in the Bayer image format to a YUV420 layout. In some embodiments, converting the input video to the second format includes performing swizzling using Y-as-green, RGGB-quadrants, RGGB-tracks, or YUV conversions. In some embodiments, the method 1000 further includes obtaining camera sensor data from a camera sensor of the mobile device in a Bayer image format, performing remosaicing of the camera sensor data, and performing binning of the camera sensor data. Block 1010 may be followed by block 1012.

At block 1012, the input video in the second format is transmitted to a server (e.g., the media server 101) for cloud processing. Block 1012 may be followed by block 1014.

At block 1014, the enhanced video is received from the server. In some embodiments, the method further includes displaying playback of the enhanced video on the mobile device; receiving a pause of the enhanced video; and displaying, with a user interface, an enhanced frame from the enhanced video, wherein the user interface includes an option to download the enhanced frame. In some embodiments, the method further includes responsive to ending a recording of the input video and before the enhanced video is received, providing a preview video that is a lower quality than the enhanced video.

In some embodiments, the method 1000 further includes displaying playback of the enhanced video on the mobile device, receiving user selection indicative of a pause of the enhanced video, and displaying, in a user interface, an enhanced frame from the enhanced video, wherein the user interface includes an option to download the enhanced frame. In some embodiments, the method further includes while recording the input video, recording a preview video of the scene and prior to receiving the enhanced video from the server, providing an option to view the preview video, where the preview video is associated with a lower quality than the enhanced video. In some embodiments, the method further includes performing, with the image signal processor, frontend processing of the preview video, conversion from the RGB color space to the YUV color space, demosaicing, applying a color correction matrix, and merging of long frames and short frames of the preview video to create merged frames.

In some embodiments, block 1002 and 1004/1006 may be performed in an initial setup of a media application 103, where the user indicates whether video enhancement is to be enabled, as described with reference to FIG. 3. The user may change their preference at any time, which may be supported by additional executions of blocks 1002 and 1004/1006.

In some embodiments, a user may record a video and select the enhancement option at a later time. In these embodiments, block 1006 may be performed after blocks 1008-1014.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method performed on a mobile device, the method comprising:
receiving a request from a user for an enhanced video;
recording an input video of a scene, wherein the input video has a first format;
converting the input video to a second format by performing, with an image signal processor of the mobile device, frontend processing and conversion from a Red Green Blue (RGB) color space to a YUV color space, wherein the input video in the second format has a smaller file size than the input video in the first format;
transmitting the input video in the second format to a server for cloud processing; and
receiving the enhanced video from the server.

2. The method of claim 1, wherein the frontend processing includes one or more actions selected from a group of linearization, black-level correction, digital gain, green channel imbalance correction, lens shading correction, white balance adjustment, highlight recovery, and combinations thereof.

3. The method of claim 1, wherein conversion to the YUV color space includes one or more actions selected from a group of spatial denoising, demosaicing, applying a color correction matrix, and converting a RGB matrix to a YUV format matrix.

4. The method of claim 1, wherein converting the input video to the second format further includes:
performing quantization of the first format that encodes the input video in 12 bits to the second format that encodes the input video in 10 bits; and
interpolating the input video in the first format by adding frames to increase a number of Frames Per Second (FPS) for the input video in the second format.

5. The method of claim 1, wherein:
the first format is a Bayer image format;
obtaining the input video in the first format includes obtaining camera sensor data from a camera sensor of the mobile device; and
converting the input video to the second format includes converting the camera sensor data in the Bayer image format to a YUV420 layout.

6. The method of claim 5, wherein converting the input video to the second format includes performing swizzling using Y-as-green, RGGB-quadrants, RGGB-tracks, or YUV conversions.

7. The method of claim 1, further comprising:
obtaining camera sensor data from a camera sensor of the mobile device in a Bayer image format;
performing remosaicing of the camera sensor data; and
performing binning of the camera sensor data.

8. The method of claim 1, further comprising:
displaying playback of the enhanced video on the mobile device;
receiving user selection indicative of a pause of the enhanced video; and
displaying, in a user interface, an enhanced frame from the enhanced video, wherein the user interface includes an option to download the enhanced frame.

9. The method of claim 1, further comprising:
while recording the input video, recording a preview video of the scene; and
prior to receiving the enhanced video from the server, providing an option to view the preview video, wherein the preview video is associated with a lower quality than the enhanced video.

10. The method of claim 9, further comprising:
performing, with the image signal processor, frontend processing of the preview video, conversion from the RGB color space to the YUV color space, demosaicing, applying a color correction matrix, and merging of long frames and short frames of the preview video to create merged frames.

11. A non-transitory computer-readable medium with instructions stored thereon that, when executed by one or more computers, cause the one or more computers to perform operations, the operations comprising:
receiving a request from a user for an enhanced video;
recording an input video of a scene, wherein the input video has a first format;
converting the input video to a second format by performing, with an image signal processor of a mobile device, frontend processing and conversion from a Red Green Blue (RGB) color space to a YUV color space, wherein the input video in the second format has a smaller file size than the input video in the first format;
transmitting the input video in the second format to a server for cloud processing; and
receiving the enhanced video from the server.

12. The non-transitory computer-readable medium of claim 11, wherein the frontend processing includes one or more actions selected from a group of linearization, black-level correction, digital gain, green channel imbalance correction, lens shading correction, white balance adjustment, highlight recovery, and combinations thereof.

13. The non-transitory computer-readable medium of claim 11, wherein conversion to the YUV color space includes one or more actions selected from a group of spatial denoising, demosaicing, applying a color correction matrix, and converting a RGB matrix to a YUV format matrix.

14. The non-transitory computer-readable medium of claim 11, wherein converting the input video to the second format further includes:
performing quantization of the first format that encodes the input video in 12 bits to the second format that encodes the input video in 10 bits; and
interpolating the input video in the first format by adding frames to increase a number of Frames Per Second (FPS) for the input video in the second format.

15. The non-transitory computer-readable medium of claim 11, wherein:
the first format is a Bayer image format;
obtaining the input video in the first format includes obtaining camera sensor data from a camera sensor of the mobile device; and
converting the input video to the second format includes converting the camera sensor data in the Bayer image format to a YUV420 layout.

16. A system comprising:
a processor; and
a memory coupled to the processor, with instructions stored thereon that, when executed by the processor, cause the processor to perform operations comprising:
receiving a request from a user for an enhanced video;
recording an input video of a scene, wherein the input video has a first format;
converting the input video to a second format by performing, with an image signal processor of a mobile device, frontend processing and conversion from a Red Green Blue (RGB) color space to a YUV color space, wherein the input video in the second format has a smaller file size than the input video in the first format;
transmitting the input video in the second format to a server for cloud processing; and
receiving the enhanced video from the server.

17. The system of claim 16, wherein the frontend processing includes one or more actions selected from a group of linearization, black-level correction, digital gain, green channel imbalance correction, lens shading correction, white balance adjustment, highlight recovery, and combinations thereof.

18. The system of claim 16, conversion to the YUV color space includes one or more actions selected from a group of spatial denoising, demosaicing, applying a color correction matrix, and converting a RGB matrix to a YUV format matrix.

19. The system of claim 16, wherein converting the input video to a second format further includes:
performing quantization of the first format that encodes the input video in 12 bits to the second format that encodes the input video in 10 bits; and
interpolating the input video in the first format by adding frames to increase a number of Frames Per Second (FPS) for the input video in the second format.

20. The system of claim 16, wherein:
the first format is a Bayer image format;
obtaining the input video in the first format includes obtaining camera sensor data from a camera sensor of the mobile device; and
converting the input video to the second format includes converting the camera sensor data in the Bayer image format to a YUV420 layout.
